(19) United States
(12) Patent Application Publication
(10) Pub. No.: US 2026/0138669 A1
(43) Pub. Date: May 21, 2026

(54) SYSTEMS AND METHODS FOR REDUCING OR AMPLIFYING FEEDBACK FORCES FOR A STEERING WHEEL OF A STEER-BY-WIRE-ENABLED VEHICLE

(71) Applicant: Adeia Guides Inc., San Jose, CA (US)

(72) Inventors: Charles Dasher, Lawrenceville, GA (US); Toshiro Ozawa, Irvine, CA (US); Christopher Phillips, Hartwell, GA (US); Mathew Adams, Matthews, NC (US)

(21) Appl. No.: 18/949,534

(22) Filed: Nov. 15, 2024

(51) Int. Cl. B62D 6/00; B62D 5/00; B62D 13/06

(52) U.S. Cl. CPC B62D 6/008; B62D 5/006; B62D 6/001; B62D 13/06

(57) ABSTRACT

Systems and methods are provided for operating a steer-by-wire (SBW)-enabled vehicle comprising a steering wheel haptics system in a quiet mode or an amplified mode. At a first time, first driving conditions for the vehicle are detected. Based on detecting the first driving conditions, a quiet mode is enabled. While operating in the quiet mode, first feedback forces transmitted from wheels of the vehicle are detected. A steering wheel of the vehicle is actuated, using the steering wheel haptics system, using a softened version of the first feedback forces. At a second time, second driving conditions are detected. Based on detecting the second driving conditions, the quiet mode is automatically switched to an amplified mode. While operating in the amplified mode, second feedback forces transmitted from the wheels of the vehicle are detected. The steering wheel is actuated using an amplified version of the second feedback forces.

### BACKGROUND

This disclosure is directed to systems and methods for reducing or amplifying feedback forces for a steering wheel of a steer-by-wire-enabled vehicle.

### SUMMARY

Steer-by-wire (SBW) technology represents a significant evolution in automotive steering systems. Traditionally, vehicles have utilized a mechanical linkage system, typically involving a steering column, shafts, and gears, to transmit the driver's steering input from the steering wheel to the vehicle's wheels. This mechanical connection provides inherent feedback to the driver, such as the sensation of road surface texture and resistance from steering efforts, often referred to as “road feel.” SBW technology, however, eliminates this mechanical linkage. Instead, SBW employs electronic systems to communicate the driver's steering inputs to the vehicle's wheels. In such systems, sensors detect the angle and torque applied to the steering wheel by the driver. These signals are then processed by a computer (e.g., an electronic control unit (ECU) or an electric power steering control unit (EPSCU)), which directs electric motors to adjust the wheels accordingly. This technology offers several advantages, including more precise and efficient steering control, reduced vehicle weight, and the potential for new vehicle designs and functionalities.

One of the challenges with SBW systems is the absence of direct physical feedback from the road. Since the steering wheel is no longer mechanically linked to the wheels, the natural tactile sensations, such as the feeling of tire impacts against road irregularities or resistance during cornering, are lost. This feedback is crucial as it plays a role in informing the driver about the interaction between the vehicle and the road surface, contributing to enhanced control and increased safety. In some approaches, force feedback mechanisms are incorporated into SBW systems to artificially simulate the tactile sensations typically experienced with traditional mechanical steering systems. Actuators in the steering system generate forces on the steering wheel that mimic the feel of the road and the impacts on the wheels. This force feedback is essential for providing the driver with intuitive information about the vehicle's handling and the road conditions. Without this haptic force feedback, a driver would not feel any connection or road feel.

While it is important that SBW systems provide force feedback to the steering wheel, it may be unnecessary for SBW systems to provide force feedback that matches the feedback that would be provided by a mechanical steering system. For example, a mechanical steering vehicle driving straight on a bumpy gravel road would provide large amounts of force feedback to the steering wheel via the steering column attached to the wheels of the vehicle. However, a driver is not expected to have to do much steering while driving on a straight road, thereby rendering the large amounts of haptic feedback unnecessary and distracting. In another example, a mechanical steering vehicle driving up to an obstacle, such as railroad tracks or a dip in the road, on an otherwise smooth road may provide a small amount of force feedback to the steering wheel. However, the driver may be expected to do more steering in the event of driving over an obstacle, thereby rendering the small amount of haptic feedback insufficient. It would be beneficial for SBW systems to dynamically create or alter road sensations to increase driver awareness and safety.

To help address these problems, the systems, methods, and apparatuses disclosed herein may be configured to enable a quiet mode or an amplified mode of force feedback in SBW-enabled vehicles in additional to a normal feedback mode of force feedback that replicates the force feedback that would be present in a mechanical steering system. In some implementations, an SBW system operates an SBW-enabled vehicle comprising a steering wheel haptics system. The steering wheel haptics system may be responsible for providing force feedback to the steering wheel to mimic mechanical steering feedback. In some embodiments, at a first time, the SBW system detects first driving conditions for the vehicle. Driving conditions may comprise a type of terrain that the vehicle is driving on, an obstacle in the road, weather conditions, geofencing, lighting conditions, any other suitable driving condition, or any suitable combination thereof. For example, the first driving conditions may be a bumpy gravel road. In some embodiments, the SBW system may input data of the driving conditions into a driver input prediction model to predict an expected amount of driver steering. In some implementations, based on the detecting the first driving conditions, the SBW system enables a quiet mode. While operating in the quiet mode, the SBW system may detect first feedback forces transmitted to the SBW system from the wheels of the vehicle. For example, the SBW system may detect forces from the bumps of gravel on the road at the wheels of, e.g., a car. In some implementations, the SBW system actuates a steering wheel of the vehicle using the steering wheel haptics system, wherein the steering wheel is actuated using a softened version of the first feedback forces. For example, the SBW system may reduce the detected feedback forces by 30%. Such aspects allow the SBW system to provide softer feedback forces than would be provided by a traditional mechanical steering system, thereby reducing distractions for the driver.

In some embodiments, at a second time, the SBW system detects second driving conditions for the vehicle. For example, the second driving conditions may be upcoming railroad tracks. In some implementations, based on the detecting the second driving conditions, the SBW system automatically switches from the quiet mode to an amplified mode. While operating in the amplified mode, the SBW system may detect second feedback forces transmitted to the SBW system from the wheels of the vehicle. For example, the SBW system may detect forces from the road leading up to the railroad crossing. In some implementations, the SBW system actuates the steering wheel of the vehicle using the steering wheel haptics system, wherein the steering wheel is actuated using an amplified version of the second feedback forces. For example, the SBW system may increase the detected feedback forces by 30%. Such aspects allow the SBW system to provide stronger feedback forces than would be provided by a traditional mechanical steering system, thereby increasing the attentiveness and safety of the driver.

In some embodiments, the SBW system automatically switches from the quiet mode to the amplified mode based on at least one of a change in driving conditions, the vehicle entering a geofenced location, or a predicted change in driving conditions. For example, the SBW system may detect that a driver has entered a location that is geofenced due to the location often having potholes. It is beneficial to provide the driver with increased force feedback to increase their awareness of the road. In some implementations, the SBW system predicting the predicted change in driving conditions comprises at least one of: (a) determining that the vehicle will enter the geofenced location within a threshold amount of time, (b) determining that the vehicle is approaching an obstacle, or (c) detecting a change in weather conditions.

In some embodiments, the SBW system operates the SBW-enabled vehicle in a normal feedback mode. While operating in the normal feedback mode, the SBW system provides the same force feedback that a traditional mechanical steering system would provide. For example, the SBW system detects third feedback forces transmitted to the steer-by-wire system from the wheels of the vehicle. The SBW system actuates the steering wheel of the vehicle using the steering wheel haptics system, wherein the steering wheel is actuated using the third feedback forces, wherein the third feedback forces are neither amplified nor softened (i.e., the same force feedback that a traditional mechanical steering system would provide). In some implementations, while the vehicle is operating in the normal feedback mode, the SBW system automatically switches to operating the vehicle in the quiet mode based on predicting a first frequency of steering wheel turns lower than a first threshold frequency of steering wheel turns. The SBW system may use a driver input prediction model to predict future driver inputs. For example, if the SBW system detects that the vehicle is expected to be driving straight on a long road, the SBW system may predict that the driver will not need to make many inputs (e.g., the driver will not need to make many steering adjustments). Thus, in order to reduce distractions, the SBW system switches to the quiet mode in order to decrease feedback force strength.

In some embodiments, while the vehicle is operating in the normal feedback mode, the SBW system automatically switches to operating the vehicle in the amplified mode based on predicting a second frequency of steering wheel turns higher than a second threshold frequency of steering wheel turns. For example, if the SBW system detects that the vehicle is driving on a winding mountain road, the SBW system may predict that the driver will need to make many inputs (e.g., the driver will need to make frequent steering adjustments). Thus, in order to increase driver road feel and safety, the SBW system switches to the amplified mode in order to increase feedback force strength. In some implementations, while the vehicle is operating in either the normal feedback mode or the quiet mode, the SBW system detects inattentive driving based on at least one sensor of the vehicle. For example, the SBW system may detect that the vehicle is drifting in its lane via a camera of the vehicle. In some embodiments, based on the detecting the inattentive driving, the SBW system automatically switches to operating the vehicle in the amplified mode. Such aspects increase the driver's attentiveness and safety.

In some implementations, the SBW system accesses a driver profile comprising tracked driving behavioral data. The tracked driving behavioral data may comprise, e.g., steering patterns, accelerometer patterns, any other suitable driving behavioral data, or any suitable combination thereof. In some embodiments, based on the tracked driving behavioral data, the SBW system determines overcorrecting driving is likely when the vehicle is driving in the first driving conditions. For example, the tracked behavioral data indicates that the steering wheel turn frequency increased beyond a sufficient turn frequency the past two days while the vehicle drove on a bumpy gravel road. In some embodiments, based on the detecting that the vehicle is driving in the first driving conditions while the vehicle is operating in the normal feedback mode, the SBW system automatically switches from the normal feedback mode to the quiet mode. Such aspects decrease the likelihood that the driver will make steering overcorrections.

In some embodiments, based on the tracked driving behavioral data, the SBW system determines undercorrecting driving is likely when the vehicle is driving in the second driving conditions. For example, the tracked behavioral data indicates that the steering wheel turn frequency decreased below a sufficient turn frequency the past two days while the vehicle drove in a geofenced region. In some embodiments, based on the SBW system detecting that the vehicle is driving in second driving conditions while the vehicle is operating in the normal feedback mode, the SBW system automatically switches from the normal feedback mode to the amplified mode. Such aspects decrease the likelihood that the driver will make steering undercorrections. In some implementations, the SBW system detects a type of terrain that the vehicle is driving on. For example, the SBW system may detect a gravel road or a snow-covered road. In some embodiments, based on the type of terrain, the SBW system automatically switches from the normal feedback mode to either the quiet mode or the amplified mode. For example, the SBW system may automatically switch to a quiet mode based on detecting the gravel road.

In some embodiments, the SBW system determines that a driver of the driver profile is hearing-impaired based on at least one of data of the driver profile or a current intensity level of auditory signals within the vehicle surpassing a threshold intensity level. For example, the SBW system may detect that the infotainment system of the vehicle is playing music at the maximum volume. In some implementations, based on the determining, the SBW system automatically switches from either the normal feedback mode or the quiet mode to the amplified mode. Such aspects may increase driver safety by bringing the driver's attention to the road. In some embodiments, the SBW system translates external auditory signals into physical feedback forces. For example, the SBW system may translate an emergency vehicle siren into physical feedback force in the steering wheel. Such aspects allow hearing-impaired drivers to be aware of sirens and other external auditory signals.

Another issue that SBW vehicles may help alleviate is the task of backing up a trailer attached to a vehicle. A vehicle that is controlled by a driver who is a novice at backing a trailer may receive steering inputs that fail to turn the steering wheel to guide the trailer in the desired direction. This results in the vehicle being repeatedly pulled forward to align the trailer behind the tow vehicle and trying to back the trailer again. Some examples of backing a trailer via a tow vehicle are backing a boat into the water on a boat ramp, backing a trailer into a garage stall, and backing a trailer to a loading ramp. Trailer length also influences the level of difficulty in backing a trailer. Longer trailers are generally easier to back up than shorter trailers. Longer trailers have more response time, while shorter trailers require faster reactions. For example, backing a 25-foot boat trailer will have less of a response and longer direction of travel with changes in steering wheel direction compared to a 13-foot personal watercraft (PWC) trailer. Thus, it is more difficult to back the 13-foot PWC trailer down a boat ramp than it is to back the 25-foot boat trailer.

In one approach, a system of the vehicle may receive information (e.g., trailer length) and the system may guide the trailer in the desired direction. This system will take over turning the non-drive-by-wire steering wheel (i.e., traditional mechanical steering) to control turning the steering wheel in the correct direction based on turning a knob on the dash of the vehicle. However, this approach is prone to errors. For example, this approach does not work in a native SBW system. Additionally, this approach does not offer the driver control over the vehicle or trailer. In another example, the driver could forget to utilize the knob, thus rendering the knob system useless to the trailer backing. Another deficiency is that existing systems consider the length of the trailer but not the width and height.

In both mechanical steering and SBW steering systems, there is a direct correlation between the amount of steering wheel turn and the amount the wheels turn. For example, a steering ratio of x:y means that a turn of the steering wheel x degree(s) causes the wheel(s) to turn y degree(s). For example, in most passenger cars, the ratio is fixed between 12:1 and 20:1. However, when backing a trailer, it may be beneficial for the steering ratio to dynamically update based on the behavior of the driver. For example, if a driver who is novice at backing trailers is turning the wheel an excessive amount, it may be beneficial to increase the steering ratio so that the excessive turning does not lead to the trailer overshooting the desired backing location.

To help address these problems, the systems, methods, and apparatuses disclosed herein may be configured to enable a trailer-optimized mode of an SBW vehicle. In some embodiments, while operating an SBW-enabled vehicle in a normal mode, the SBW system is configured to operate using a first steering ratio, wherein turning a steering wheel of the vehicle and turning of at least one wheel of the vehicle are correlated by the first steering ratio. For example, the first steering ratio may be 15:1. In some implementations, based on detecting that a trailer is attached to the vehicle, the SBW system initiates a trailer-optimized mode. The SBW system may detect the trailer attachment by at least one sensor of the vehicle. In some embodiments, while operating the vehicle in the trailer-optimized mode, the SBW system accesses a profile of the trailer to determine dimensions of the trailer. For example, the SBW system may determine the dimensions of the trailer by at least one of: (a) receiving a user interface input indicating the dimensions of the trailer, (b) detecting the dimensions of the trailer via sensors of the vehicle, or (c) identifying the dimensions of the trailer from a database of trailer dimension data.

In some implementations, while operating the vehicle in the trailer-optimized mode, the SBW system is adjusted to operate the vehicle using a second steering ratio, wherein turning the steering wheel of the vehicle and turning of at least one wheel of the vehicle are correlated by the second steering ratio. In some implementations, operating the SBW system using the second steering ratio results in turning of at least one wheel of the vehicle being less sensitive to turning of the steering wheel compared to operating the SBW system using the first steering ratio. For example, the second steering ratio may be 30:1. Such aspects reduce sensitivity of the steering wheel such that overcorrections made by the driver do not affect the steering of the trailer. In some embodiments, the second steering ratio is based on the dimensions of the trailer. For example, the steering ratio may be increased or decreased depending on the length and width of the trailer.

In some embodiments, the SBW system accesses learned driving behavioral data stored in the profile of the trailer. For example, the SBW system may determine, based on the behavioral data, that the driver of the vehicle tends to oversteer when backing the trailer. Based at least in part on the learned driving behavioral data, in some implementations, the SBW modifies the second steering ratio, wherein operating the vehicle using the modified second steering ratio results in turning of at least one wheel of the vehicle being less sensitive to turning of the steering wheel compared to operating the steer-by-wire system using the second steering ratio. While operating the vehicle in the trailer-optimized mode, in some embodiments, the SBW system detects that the vehicle has switched between forward and backwards movement a particular number of times. For example, the vehicle may have switched between reverse and drive five times.

Based on determining that the particular number of times exceeds a threshold number of times, the SBW system may provide a user-selectable option to enter an inverted steering mode. In some implementations, the SBW system identifies a target location for the trailer. Based on determining that the trailer is not moving toward or is not predicted to arrive at the target location, the SBW system may provide a user-selectable option to enter an inverted steering mode. In response to receiving a user selection of the user-selectable option to enter the inverted steering mode, the SBW system may initiate the inverted steering mode. In some embodiments, while operating in the inverted steering mode, the SBW system inverts steering direction such that turning the steering wheel of the vehicle in one direction results in at least one wheel of the vehicle turning in the opposite direction. When steering is not inverted, to back a trailer in a desired direction (e.g., left), the steering wheel of the vehicle must be turned in the opposite direction (e.g., right). This can be counterintuitive for drivers, particularly drivers who are novices at backing trailers. Therefore, inverting the steering of the vehicle such that turning the steering wheel of the vehicle in one direction results in backing the trailer in the same direction may be beneficial for novice trailer-backing drivers. Such aspects protect the vehicle from unnecessary wear and tear and fuel usage.

In some implementations, while operating the vehicle in the trailer-optimized mode, the SBW system limits a speed of the vehicle such that the speed does not exceed a threshold speed. For example, the SBW system may limit the speed of the vehicle to five miles per hour while operating the vehicle in the trailer-optimized mode. Such aspects increase safety of the driver and nearby people and objects. In some embodiments, while operating the vehicle in the trailer-optimized mode, the SBW system provides at least one notification on at least one portion of the exterior of the vehicle that the vehicle is operating in the trailer-optimized mode, wherein the at least one notification is at least one of an audible notification or a visual notification. For example, the SBW system may generate, via an external speaker of the vehicle, an auditory alert while the vehicle is operating in the trailer-optimized mode. Such aspects alert people around the trailer and vehicle that the vehicle is backing the trailer.

In some implementations, while operating the vehicle in the normal mode, the SBW system detects that the trailer is attached to the vehicle and that the vehicle has switched between forward and backwards movement a particular number of times. Based on determining that the particular number of times exceeds a threshold number of times, the SBW system may provide a user-selectable option to enter the trailer-optimized mode. While in some embodiments the SBW system automatically enters the trailer-optimized mode, in some other embodiments the SBW system provides the option to enter the trailer-optimized mode to the driver. Such aspects allow the driver the choice to enter the trailer-optimized mode. Similarly, based on determining that the trailer is not moving toward or is not predicted to arrive at a desired location while operating the vehicle in the normal mode, the SBW system may provide the user-selectable option to enter the trailer-optimized mode.

In some implementations, while operating the vehicle in the trailer-optimized mode, based on determining that the vehicle has switched between forward and backwards movement a particular number of times exceeding a threshold number of times, the SBW system operates the vehicle using a third steering ratio, wherein turning the steering wheel of the vehicle and turning of at least one wheel of the vehicle are correlated by the third steering ratio. The SBW operating the vehicle using the third steering ratio results in turning of at least one wheel of the vehicle being less sensitive to turning of the steering wheel compared to using the second steering ratio. Such aspects reduce sensitivity of the steering wheel such that overcorrections made by the driver do not affect the steering of the trailer.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative example of enabling a trailer-optimized mode for an SBW-enabled vehicle backing a trailer, in accordance with some embodiments of this disclosure.

FIG. 2 shows an illustrative example of enabling an inverted steering mode while operating an SBW-enabled vehicle in a trailer-optimized mode, in accordance with some embodiments of this disclosure.

FIG. 3 shows an illustrative example of enabling a quiet mode or an amplified mode of force feedback in SBW-enabled vehicles, in accordance with some embodiments of this disclosure.

FIG. 4 shows an illustrative example of a driver input prediction model, in accordance with some embodiments of this disclosure.

FIG. 5 shows an illustrative example of a user interface for enabling a quiet mode or an amplified mode for an SBW-enabled vehicle, in accordance with some embodiments of this disclosure.

FIG. 6 is a block diagram of an exemplary SBW system, in accordance with some embodiments of this disclosure.

FIG. 7 is a flowchart of a detailed illustrative process for enabling a trailer-optimized mode for an SBW-enabled vehicle backing a trailer, in accordance with some embodiments of this disclosure.

FIG. 8 is a flowchart of a detailed illustrative process for enabling a quiet mode or an amplified mode of force feedback in SBW-enabled vehicles, in accordance with some embodiments of this disclosure.

FIG. 9 is a sequence diagram of a detailed illustrative process for enabling a quiet mode or an amplified mode of force feedback in SBW-enabled vehicles based on terrain type and navigational features, in accordance with some embodiments of this disclosure.

### DETAILED DESCRIPTION

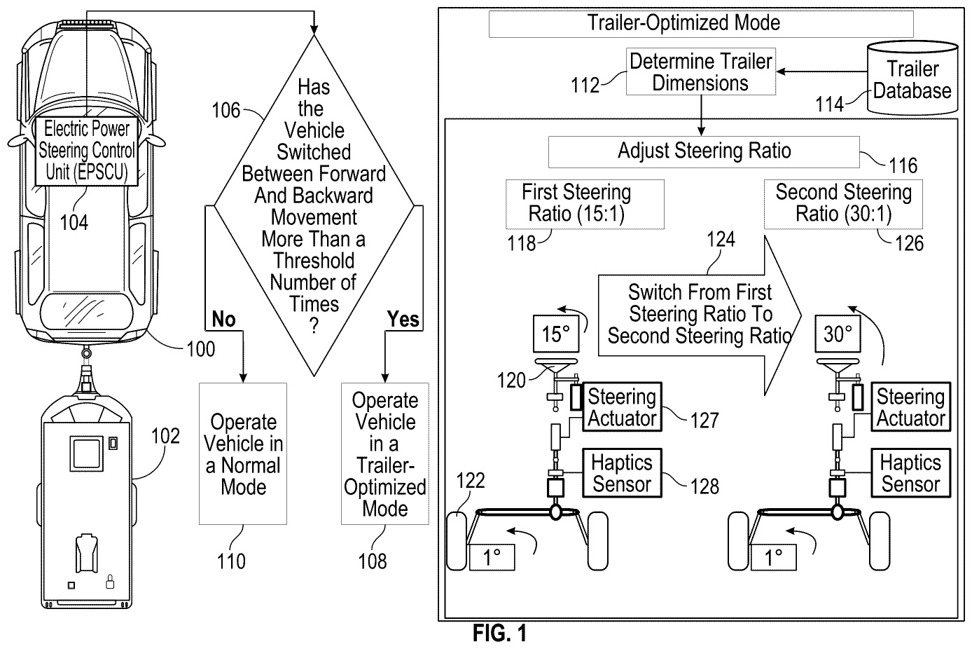

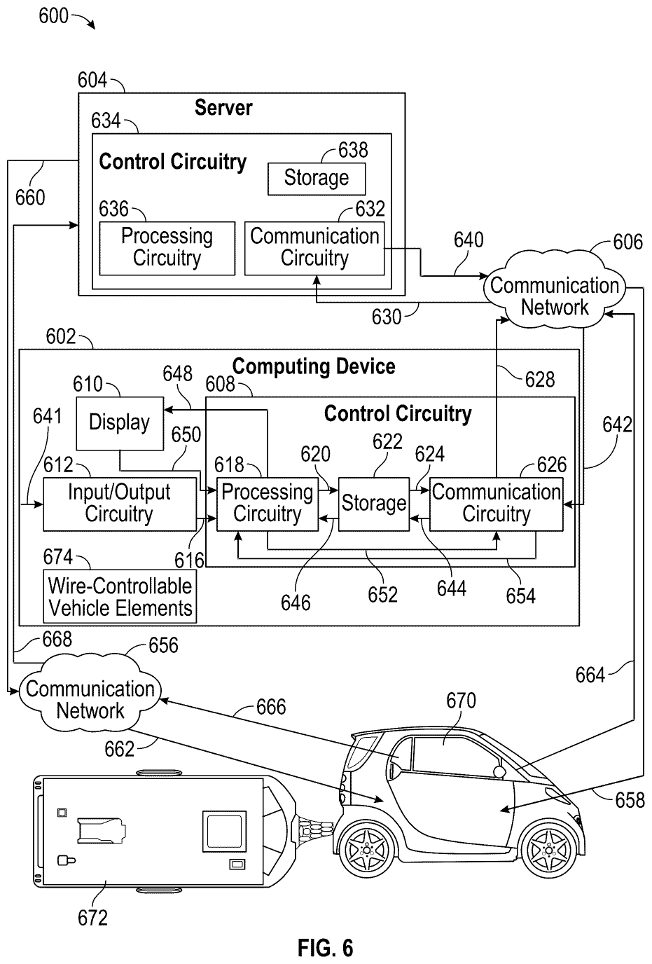

FIG. 1 shows an illustrative example of enabling a trailer-optimized mode for an SBW-enabled vehicle backing a trailer, in accordance with some embodiments of this disclosure. In some embodiments, an electric control unit (ECU) of the vehicle (e.g., vehicle 100) runs an SBW system. A vehicle is a machine that transports people or goods from one place to another place and may operate using an engine and/or a motor. The vehicle may receive power via a fuel tank and/or a battery. A vehicle may have at least one ECU, however a vehicle usually has a plurality of ECUs. Examples of ECUs include an engine control module (ECM), electric power steering control unit (ESPCU), powertrain control module (PCM), transmission control module (TCM), brake control module (BCM), any other suitable ECU, or any suitable combination thereof. The ECU may comprise, for example, the circuitries described in connection with FIG. 6 such as control circuitry, processing circuitry, communication circuitry, and input/output circuitry. The SBW system may comprise elements such as steering wheel 120, steering actuator 127, haptics sensor 128, at least one wheel 122, any other suitable hardware or software element, or any suitable combination thereof.

The ECU may comprise embedded software of the SBW system. In some implementations, a separate hardware component runs the SBW system, e.g., EPSCU 104. The ECU (e.g., ESPCU 104), may use the circuitries described in connection with FIG. 6. Vehicle 100 may be a car, a truck, a motorcycle, a three-wheeled trike, a bus, a van, a tractor, any other suitable vehicle, or any suitable combination thereof. In some embodiments, an SBW application runs on a processor of the SBW system (e.g., processing circuitry 636 and/or processing circuitry 618 and/or wire-controllable vehicle elements 674 of FIG. 6). The SBW system may run the SBW application. In some embodiments, while operating vehicle 100 in a normal mode, the SBW system operates using a first steering ratio (e.g., first steering ratio 118). For example, the first steering ratio may be 15:1. When the SBW system receives input from the steering wheel (e.g., steering wheel 120) turning 15 degrees, the SBW system turns at least one wheel of vehicle 100 (e.g., wheel 122) one degree via an actuator (e.g., steering actuator 127). Steering actuator 127 may have received an indication of steering wheel 120 turning from ESPCU 104. Based on detecting that a trailer (e.g., trailer 102) is attached to vehicle 100, in some embodiments, the SBW system initiates a trailer-optimized mode.

Trailer 102 may be another vehicle such as a car or a boat, an auto hauler, an equipment trailer, a recreational vehicle (RV) a flatbed, an enclosed trailer, any other suitable trailer type, or any suitable combination thereof. The SBW system may detect that trailer 102 is attached to vehicle 100 by detecting a power draw from the battery of vehicle 100, indicating that trailer 102 is plugged into a power source of vehicle 100 (e.g., to power the lights of trailer 102). In some embodiments, the SBW system detects that trailer 102 is attached to vehicle 100 by receiving a manual input from a driver of vehicle 100 indicating that trailer 102 is attached to vehicle 100. The SBW system may receive the manual input from a user interface of an infotainment center of vehicle 100.

In some implementations, at 106, the SBW system determines whether vehicle 100 has switched between forward and backward movement more than a threshold number of times. The threshold number of times may be predetermined by the SBW system. For example, the SBW system may detect that vehicle 100 has switched from reverse to drive five times within two minutes. If the SBW does not detect a number exceeding the threshold number, at 110, the SBW may continue operating vehicle 100 in the normal mode (e.g., operate vehicle 100 with first steering ratio 118). If the SBW system does detect a number exceeding the threshold number, at 108, the SBW system may operate vehicle 100 in the trailer-optimized mode. In some embodiments, based on determining that the particular number of times exceeds a threshold number of times, the SBW system provides a user-selectable option to enter the trailer-optimized mode. In response to receiving a selection of the user-selectable option, the SBW system may enter the trailer-optimized mode.

In some implementations, the SBW system determines a desired location of trailer 102. The desired location of trailer 102 may be input via a user-interface selection and/or detected by at least one sensor of trailer 102. For example, the SBW system receives the input via the user-interface selection on a user interface in vehicle 100, such as an infotainment system user interface, or on a user device connected to vehicle 100 such as a smartphone. In another example, the SBW system receives the input via at least one sensor of trailer 102, such as detecting dimensions of a proximate parking spot indicated by yellow lines using a camera of trailer 102 and or vehicle 100. Based on determining that trailer 102 is not moving toward or is not predicted to arrive at the desired location, the SBW system may provide a user-selectable option to enter the trailer-optimized mode. The user-selectable option may be displayed on a user interface of vehicle 100, a user interface of a connected user device, and/or generated audibly by the infotainment system of vehicle 100 or by the connected user device.

While operating vehicle 100 in the trailer-optimized mode, in some embodiments, the SBW system accesses a profile of trailer 102 to determine dimensions of trailer 102. The profile of trailer 102 may comprise driver behavioral data and data about trailer 102. The profile of trailer 102 may be stored in memory of EPSCU 104, in trailer database 114, in a remote server, any other suitable storage, or any suitable combination thereof. In some implementations, the SBW system may determine the dimensions of trailer 102 via sensors of vehicle 100. For example, a camera of vehicle 100 may provide measurements of the length and width of trailer 102 to the SBW system. In another example, at 112, the SBW system receives data of the dimensions of trailer 102 from trailer database 114. The length, width, and height of trailer 102 all have effects on how trailer 102 will react to backing, e.g., by affecting the resistance to angular acceleration, center of gravity, and frontal area.

In some embodiments, the SBW system, at 116, adjusts the steering ratio of EPSCU 104 to operate using a second steering ratio (e.g., second steering ratio 126). For example, at 124, the SBW system switches from first steering ratio 118 (e.g., 15:1) to second steering ratio 126 (e.g., 30:1). When the SBW system receives input from an actuator of steering wheel 120 turning 30 degrees, the SBW system turns wheel 122 one degree. The second steering ratio may be based on the dimensions of trailer 102. In some implementations, second steering ratio 126 results in turning of wheel 122 of vehicle 100 being less sensitive to turning of steering wheel 120 compared to operating using first steering ratio 118. When the SBW system operates vehicle 100 with second steering ratio 126, the SBW system must receive more input from an actuator of steering wheel 120 (e.g., more degrees turned) to move wheel 122 the same amount as before the steering ratio adjustment (e.g., one degree). Second steering ratio 126 allows vehicle 100 more room for error, as larger turns of steering wheel 120 will have less effect on the turning of wheel 122.

In some embodiments, while operating in the trailer-optimized mode, the SBW system limits a speed of vehicle 100 such that the speed does not exceed a threshold speed. For example, the SBW system may limit the speed of vehicle 100 to three miles per hour while operating in the trailer-optimized mode. In some implementations, the SBW system provides at least one notification on at least one portion of the exterior of vehicle 100 that vehicle 100 is operating in the trailer-optimized mode, wherein the at least one notification is at least one of an audible notification or a visual notification. For example, a back-up beeper of vehicle 100 may generate an auditory alarm to alert people and vehicles that vehicle 100 is operating in the trailer-optimized mode. In another example, taillights and/or headlights of vehicle 100 may flash to alert people and vehicles that vehicle 100 is operating in the trailer-optimized mode.

In some embodiments, the SBW system accesses tracked driving behavioral data stored in the profile of trailer 102. For example, the SBW system may track, e.g., how many times vehicle 100 switches from forward to backward movement in a given trailer-backing session, the amount steering wheel 120 turns in a given trailer-backing session (e.g., if a driver overcorrects or undercorrects while backing trailer 102), any other suitable driving behavioral data, or any suitable combination thereof. Overcorrection may occur when a driver feels they are losing control of the vehicle, causing the driver to steer more than a sufficient amount. The SBW system may detect overcorrection by sudden and/or large movement of steering wheel 120. Undercorrection may occur when a driver does not steer a sufficient amount to stay on the desired path/guide trailer 102 to the desired location. The SBW system may detect undercorrection by detecting low amounts of steering input that are not sufficient for guiding trailer 102 to the desired location.

Based at least in part on the learned driving behavioral data, the SBW system modifies second steering ratio 126, wherein operating vehicle 100 using the modified second steering ratio (e.g., a third steering ratio) results in turning of wheel 122 of vehicle 100 being less sensitive to turning of steering wheel 120 compared to operating vehicle 100 using second steering ratio 126. In some embodiments, based on determining that the particular number of times exceeds the threshold number of times, the SBW system adjusts the steering ratio of vehicle 100 to operate using a third steering ratio, wherein the third steering ratio is based on the dimensions of trailer 102 and results in turning of wheel 122 of vehicle 100 being less sensitive to turning of steering wheel 120 compared to using second steering ratio 126.

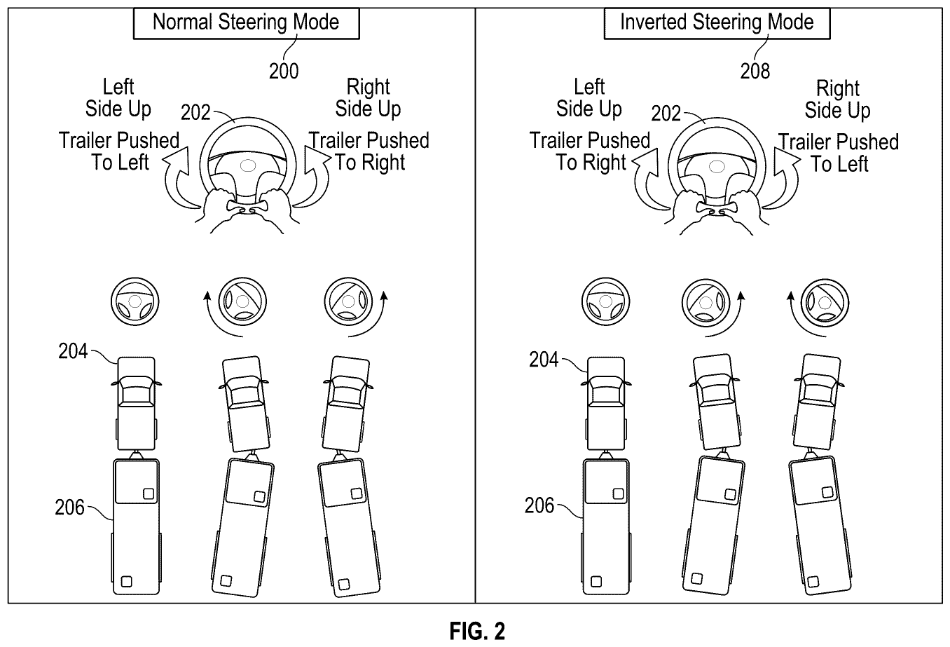

FIG. 2 shows an illustrative example of enabling an inverted steering mode while operating an SBW-enabled vehicle in a trailer-optimized mode, in accordance with some embodiments of this disclosure. Based on detecting that a trailer (e.g., trailer 206) is attached to a vehicle (e.g., vehicle 204), an SBW system (e.g., the SBW system as described in connection with FIG. 1) may operate vehicle 204 in a trailer-optimized mode, as described in connection with FIG. 1. In some embodiments, the SBW system operates vehicle 204 in both the trailer-optimized mode and the inverted steering mode. In some embodiments, the SBW system operates vehicle 204 in the inverted steering mode without also operating vehicle 204 in the trailer-optimized mode. While operating in the trailer-optimized mode, the SBW system may operate in a normal steering mode (e.g., normal steering mode 200). While operating in normal steering mode 200, the SBW system may receive a steering input from the driver via an actuator of steering wheel 202 of vehicle 204. If the steering input turns steering wheel 120 to the right (e.g., the left side of steering wheel 202 is pushed up), the SBW system turns at least one wheel of vehicle 204 to the right.

While backing a trailer (e.g., trailer 206) in normal steering mode 200, the SBW system turning at least one wheel of vehicle 204 to the right turns at least one wheel of trailer 206 to the left. Conversely, in normal steering mode 200, the SBW system turning at least one wheel of vehicle 204 to the left turns at least one wheel of trailer 206 to the right. In some implementations, the SBW system detects vehicle 204 has switched between forward and backwards movement a particular number of times while attempting to back trailer 206. In some embodiments, the SBW system determines a frequency of gear shifts and/or drive direction changes. The SBW system may analyze a distance traveled and/or displacement from an initial location. For example, while driving in normal steering mode 200, the SBW system detects that vehicle 204 has gone from drive to reverse five times in two minutes. Based on determining that the particular number of times exceeds a threshold number of times (e.g., four times in two minutes), in some embodiments, the SBW system provides a user-selectable option to enter an inverted steering mode (e.g., inverted steering mode 208). In response to receiving a user selection of the user-selectable option to enter inverted steering mode 208, the SBW system initiates inverted steering mode 208.

In some embodiments, while operating in inverted steering mode 208, the SBW system inverts steering direction such that turning steering wheel 202 of vehicle 204 in one direction results in at least one wheel of vehicle 204 turning in the opposite direction. The SBW system may reverse the input of steering wheel 202 such that an actuator connected to at least one wheel of vehicle 204 turns at least one wheel in the opposite direction. The SBW system operating vehicle 204 in inverted steering mode 208 will guide trailer 206 in the same direction that steering wheel 202 is turned.

For example, while operating vehicle 204 in inverted steering mode 208, the SBW system receives a steering input from an actuator of steering wheel 202 indicating that steering wheel 202 is turned right (e.g., the left side of steering wheel 202 is pushed up). In response, the SBW system turns at least one wheel of vehicle 204 to the left. This will guide trailer 206 to the right (e.g., the desired direction). In some implementations, the SBW system only inverts the steering direction (e.g., only operates in inverted steering mode 208) while vehicle 204 is in reverse (e.g., backing trailer 206). The SBW system may return to operating vehicle 204 in normal steering mode 200 while vehicle 204 is in drive or another forward-accelerating gear.

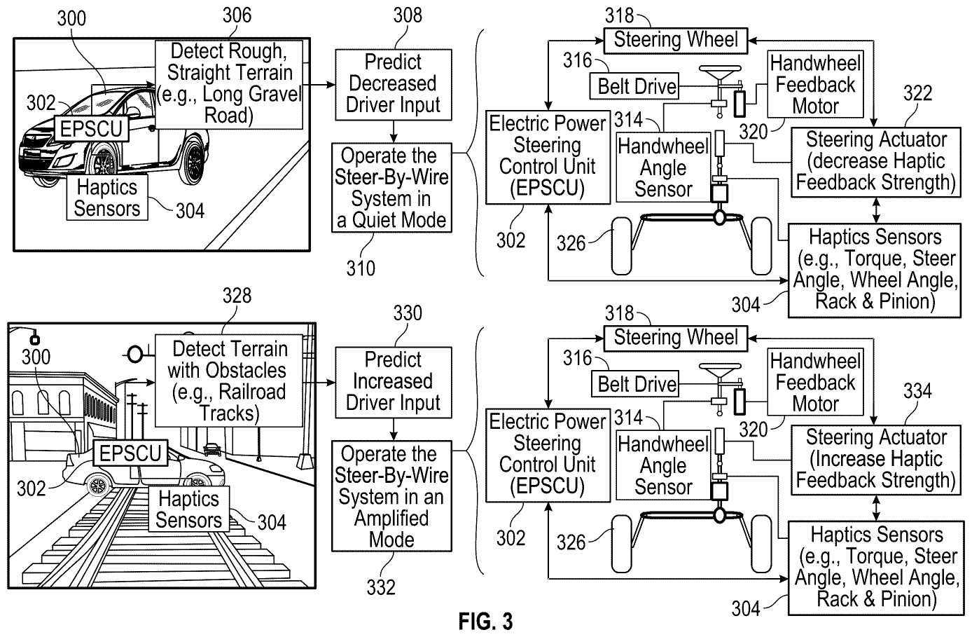

FIG. 3 shows an illustrative example of enabling a quiet mode or an amplified mode of force feedback in SBW-enabled vehicles, in accordance with some embodiments of this disclosure. In some embodiments, a vehicle (e.g., vehicle 300, vehicle 330, vehicle 100 of FIG. 1, or vehicle 204 of FIG. 2) comprises a steering wheel haptics system. The steering wheel haptics system may be integrated into an SBW system (e.g., the SBW system as described in FIGS. 1-2). In some implementations, the steering wheel haptics system is implemented by the ECU or EPSCU of the vehicle (e.g., EPSCU 302 or EPSCU 332). In some embodiments, the steering wheel haptics system is separately implemented by an additional hardware component of vehicle 300. Haptics sensors 304 may be connected to the steering wheel haptics system.

In some implementations, the SBW system operates vehicle 300 in a normal feedback mode. While operating in the normal feedback mode, the SBW system may detect feedback forces transmitted from the wheels of vehicle 300 (e.g., wheel 326). For example, while the vehicle is driven on a highway, the SBW system receives, via EPSCU 302, haptics data of feedback forces on wheel 326. In some embodiments, the SBW system actuates steering wheel 318 using the feedback forces from haptics sensors 304. While operating in the normal feedback mode, the feedback forces are neither amplified nor softened. The normal feedback mode mimics feedback forces of a traditional, mechanical steering system such that the driver of vehicle 300 receives haptic feedback of the road through steering wheel 318. In some embodiments, belt drive 316 works with handwheel feedback motor 320 and handwheel angle sensor 314 to provide force feedback to steering wheel 318. Force feedback may comprise force in a vertical direction (e.g., y-direction), a horizontal direction (e.g., x-direction), perpendicular direction (e.g., z-direction) and may be actuated as vibrations and/or torque. For example, the SBW system may provide a maximum of five Newton meters (Nm) of torque force on steering wheel 318 in addition to vibrations of steering wheel 318 while operating in the normal feedback mode.

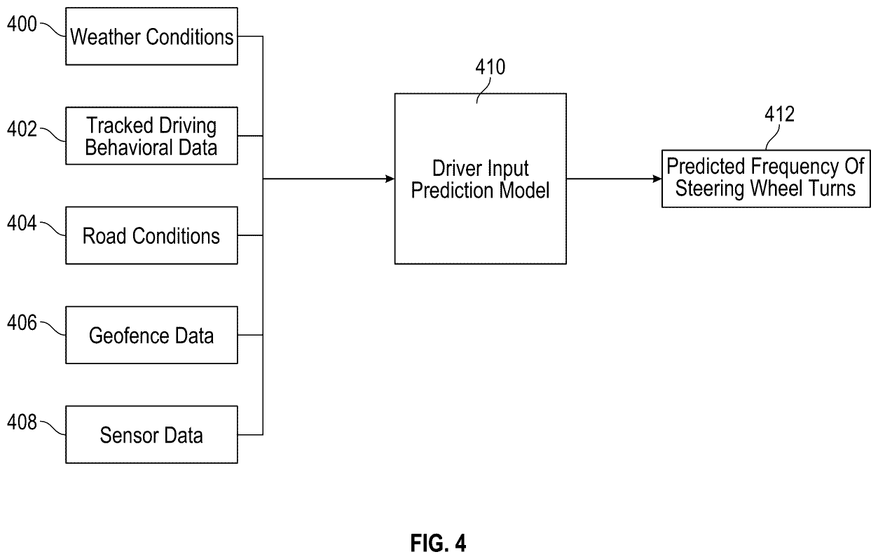

In some embodiments, at a first time, at 306, the SBW system detects first driving conditions for vehicle 300. Driving conditions may comprise a type of terrain that vehicle 300 is driving on, an obstacle in the road, weather conditions, geofencing, lighting conditions, traffic conditions, any other suitable driving condition, or any suitable combination thereof. For example, at 306, the SBW system detects the vehicle 300 is driving on a long gravel road with many bumps. In some implementations, at 308, the SBW system predicts decreased driver input. For example, the SBW system may predict a frequency of steering wheel turns lower than a threshold frequency of steering wheel turns. The SBW system may use a driver input prediction model (e.g., driver input prediction model 410 as described in connection with FIG. 4) to predict the frequency of steering wheel turns. For example, on a long straight road, the SBW system may predict a low frequency of steering wheel turns for the next hour (e.g., approximately 10 small adjustments in one hour as vehicle 300 drives along the road).

In some implementations, based on the detecting the first driving conditions, at 310, the SBW system may enable operating in a quiet mode. While operating in the quiet mode, the SBW system may detect first feedback forces transmitted from wheel 326 of vehicle 300. For example, the SBW system detects many bumps and/or potholes in the gravel road. In the quiet mode, the SBW system actuates steering wheel 318 of vehicle 300 using the steering wheel haptics system, wherein steering wheel 318 is actuated using a softened version of the first feedback forces. For example, the SBW system may reduce the detected feedback forces by 30%. In some embodiments, the SBW system reduces different feedback forces by different amounts. For example, the SBW system may reduce the torque force from five Nm to four Nm (i.e., 20% reduction) while reducing the vibrations by 40%. The SBW system may adjust the feedback forces based on the intensity of the driving conditions. For example, while vehicle 300 is driven over a slightly bumpy road, the SBW system may reduce the vibrations actuated in the steering wheel 318 by 20% in the z-direction while maintaining an unmodified torque force (e.g., the torque force that the SBW system would actuate while operating vehicle 300 in the normal feedback mode). In another example, while vehicle 300 is driven over an extremely bumpy road with large rocks, the SBW system may reduce the vibrations by 40% in the x, y, and z-directions while reducing torque by 20%. The driving conditions may be inputs to a heuristic or neural network model, such as driver input prediction model 410 (as described in connection with FIG. 4).

In some embodiments, at a second time, at 328, the SBW system detects second driving conditions for vehicle 300. For example, the SBW system detects that vehicle 300 is approaching an intersection with railroad tracks. At 330, the SBW system may predict increased driver input. For example, the SBW system may predict a frequency and/or strength of steering wheel turns higher than a threshold frequency of steering wheel turns. The SBW system may use a driver input prediction model (e.g., driver input prediction model 410 as described in connection with FIG. 4) to predict the frequency and/or strength of steering wheel turns. For example, the SBW system predicts that steering wheel 318 will require greater input (e.g., adjustments to correct steering) while driving over the railroad tracks than driving over a smooth road (e.g., five adjustments within 20 seconds). In some implementations, based on predicting a frequency higher than a threshold frequency (e.g., three adjustments within 20 seconds), at 332, the SBW system automatically switches from operating vehicle 300 in the quiet mode to operating vehicle 300 in an amplified mode. In some embodiments, the SBW system switches to operating vehicle 300 in the amplified mode based on vehicle 300 entering a trailer-optimized mode, as described in connection with FIG. 1.

In some embodiments, while operating in the amplified mode, the SBW system may detect second feedback forces transmitted from wheel 326 of vehicle 300. For example, the SBW system detects bumps from the railroad tracks. In the amplified mode, the SBW system actuates steering wheel 318 of vehicle 300 using the steering wheel haptics system, wherein steering wheel 318 is actuated using an amplified version of the second feedback forces. For example, the SBW system may increase the detected feedback forces by 30%. In some implementations, while the vehicle is operating in either the normal feedback mode or the quiet mode, the SBW system detects inattentive driving based on at least one sensor of vehicle 300. For example, the SBW system may detect inattentive driving based on vehicle 300 drifting and/or swerving in its lane using a camera of vehicle 300 and/or haptics sensors 304. In another example, the SBW system detects drowsiness of the driver of vehicle 300 via sensors tracking eye movement. Based on the detecting the inattentive driving, the SBW system may automatically switch to operating vehicle 300 in the amplified mode.

In some embodiments, the SBW system detects a type of terrain that vehicle 300 is driving on. For example, the SBW system may detect a gravel road, a snow-covered road, a wet road, a sandy road, a dirt road, a bumpy road, any other type of terrain, or any suitable combination thereof. The SBW system may detect the type of terrain via at least one sensor of vehicle 300, such as haptics sensors 304 and/or a camera, and/or geographic data and/or weather data obtained from a database. Based on the detected terrain, in some implementations, the SBW system automatically switches to operating vehicle 300 in the quiet mode or the amplified mode. For example, based on detecting bumpy terrain, the SBW system may automatically switch from operating vehicle 300 in the normal feedback mode to operating vehicle 300 in the quiet mode. In another example, based on detecting a wet road, the SBW system may automatically switch from operating vehicle 300 in the normal feedback mode to operating vehicle 300 in the amplified mode.

FIG. 4 shows an illustrative example of a driver input prediction model, in accordance with some embodiments of this disclosure. In some embodiments, a vehicle (e.g., vehicle 300 of FIG. 3, vehicle 100 of FIG. 1, or vehicle 204 of FIG. 2) comprises a steering wheel haptics system. The steering wheel haptics system may be integrated into an SBW system (e.g., the SBW system as described in FIGS. 1-3). The SBW system may comprise a driver input prediction model (e.g., driver input prediction model 410). Driver input prediction model 410 may be used to predict a frequency and/or intensity of driver input. In some embodiments, driver input prediction model 410 is a heuristic model. In some implementations, driver input prediction model 410 is a neural network trained using machine learning, such as support vector machines (SVMs), multilayer perceptrons (MLPs), convolutional neural networks (CNNs), any other suitable machine learning algorithm, or any suitable combination thereof. In some embodiments, driver input prediction model 410 is trained using historical data from at least one sensor of vehicle 300 and/or any of input data 400-408.

In some implementations, the SBW system automatically switches from the quiet mode to the amplified mode based on at least one of a change in driving conditions, the vehicle entering a geofenced location, or a predicted change in driving conditions. The SBW system may predict the predicted change in driving conditions by at least one of (a) determining that the vehicle will enter the geofenced location within a threshold amount of time, (b) determining that the vehicle is approaching an obstacle, or (c) detecting a change in weather conditions. In some embodiments, the SBW system predicts the change in driving conditions using driver input prediction model 410. Driver input prediction model 410 may receive as inputs weather conditions 400 data, tracked driving behavioral data 402, road conditions 404 data, geofence data 406, sensor data 408, any other suitable input data, or any suitable combination thereof. For example, driver input prediction model 410 receives weather conditions 400 from a thermistor of vehicle 300 and a rain sensor of vehicle 300. In some embodiments, driver input prediction model 410 receives as input data that vehicle 300 is operating in the trailer-optimized mode, as described in connection with FIGS. 1-2.

In some embodiments, based on inputs 400-408, the SBW system, using driver input prediction model 410, outputs a predicted frequency and/or intensity of steering wheel turns (e.g., predicted frequency of steering wheel turns 412). For example, driver input prediction model 410 may output a high predicted frequency of steering wheel turns (e.g., steering wheel 318 of vehicle 300) based on receiving input data of cold and rainy conditions (e.g., weather conditions 400). In another example, driver input prediction model 410 may output a low predicted frequency of steering wheel turns based on receiving input data of a long, straight road (e.g., geofence data). In some implementations, based on predicted frequency of steering wheel turns 412, the SBW system may automatically switch from the normal feedback mode to either the quiet mode or the amplified mode, from the quiet mode to either the normal feedback mode or the amplified mode, or from the amplified mode to either the normal feedback mode or the quiet mode. For example, a high predicted frequency may cause the SBW system to switch from operating vehicle 300 in the normal feedback mode to operating vehicle 300 in the amplified mode.

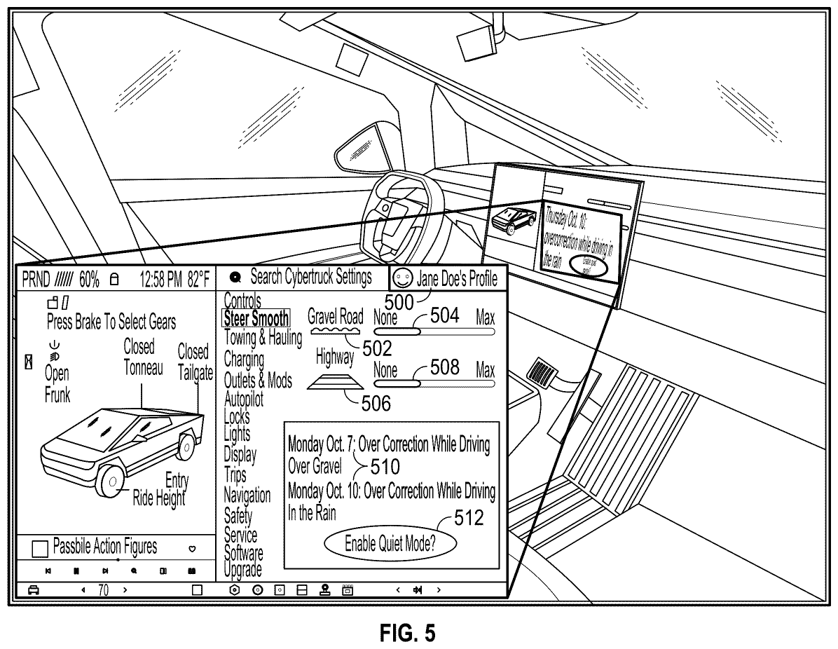

FIG. 5 shows an illustrative example of a user interface for enabling a quiet mode or an amplified mode for an SBW-enabled vehicle, in accordance with some embodiments of this disclosure. In some embodiments, an SBW system (e.g., the SBW system as described in connection with FIGS. 1-4) accesses a driver profile (e.g., driver profile 500) comprising tracked driving behavioral data (e.g., tracked driving behavioral data 402 of FIG. 4). Driver profile 500 may be stored in a memory of the vehicle (e.g., vehicle 300 of FIG. 3), in the ECU or ESPCU of vehicle 300, in a driver data database, in a remote server, any other suitable storage, or any suitable combination thereof. Driver profile 500 may comprise driving conditions data, such as terrain data (e.g., gravel road 502) and road data (e.g., highway 506), as well as an intensity scale of the terrain data (e.g., scale 504) and an intensity scale of the road data (e.g., scale 508). In some implementations, the SBW system generates for display a user interface comprising driver profile 500 in the infotainment center of vehicle 300.

Driver profile 500 may comprise driving behavioral data tracked by the SBW system over time. In some embodiments, the SBW system may track steering inputs, driving conditions, vehicle speed, any other suitable driving behavior data, or any suitable combination thereof. For example, the SBW system tracks driving behavior, the driving conditions present while the driving behavior occurred, and the date and/or time of the driving behavior (e.g., overcorrection while driving over gravel on Monday October 7 and overcorrection while driving in the rain on Thursday October 10). The SBW system may generate for display indications of the tracked driving behavior (e.g., tracked driving behavioral data 510). Based on the tracked driving behavioral data, in some implementations, the SBW system determines overcorrecting driving is likely when vehicle 300 is driving in the first driving conditions. For example, based on tracked driving behavioral data 510, the SBW system may predict that a driver of vehicle 300 is likely to overcorrect while driving on a gravel road (e.g., first driving conditions).

The SBW system may detect that vehicle 300 is driving in first driving conditions while vehicle 300 is operating in the normal feedback mode. For example, the SBW system detects, via at least one sensor of vehicle 300, that vehicle 300 is driving on a gravel road while operating vehicle 300 in the normal feedback mode. In some embodiments, based on the detecting, the SBW system automatically switches from the normal feedback mode to the quiet mode. In some embodiments, based on the detecting, the SBW system provides a driver of the vehicle with a user-selectable option to enable quiet mode (e.g., user-selectable option 512). User-selectable option 512 may be displayed on a user interface comprising driver profile 500 and/or may be generated audibly. In response to receiving a user selection of user-selectable option 512, the SBW system switches from operating vehicle 300 in the normal feedback mode to operating vehicle 300 in the quiet mode.

Similarly, in some embodiments, based on the tracked driving behavioral data, the SBW system determines undercorrecting driving is likely when vehicle 300 is driving in the second driving conditions. For example, based on tracked driving behavioral data 510, the SBW system may predict that a driver of vehicle 300 is likely to undercorrect while driving in second driving conditions (e.g., on a wet road). The SBW system may detect that vehicle 300 is driving in the second driving conditions while vehicle 300 is operating in the normal feedback mode and based on the detecting, automatically switch from the normal feedback mode to the amplified mode. For example, based on detecting that vehicle 300 is driving on a wet road while operating in the normal feedback mode, the SBW system may switch from operating in the normal feedback mode to operating in the amplified mode.

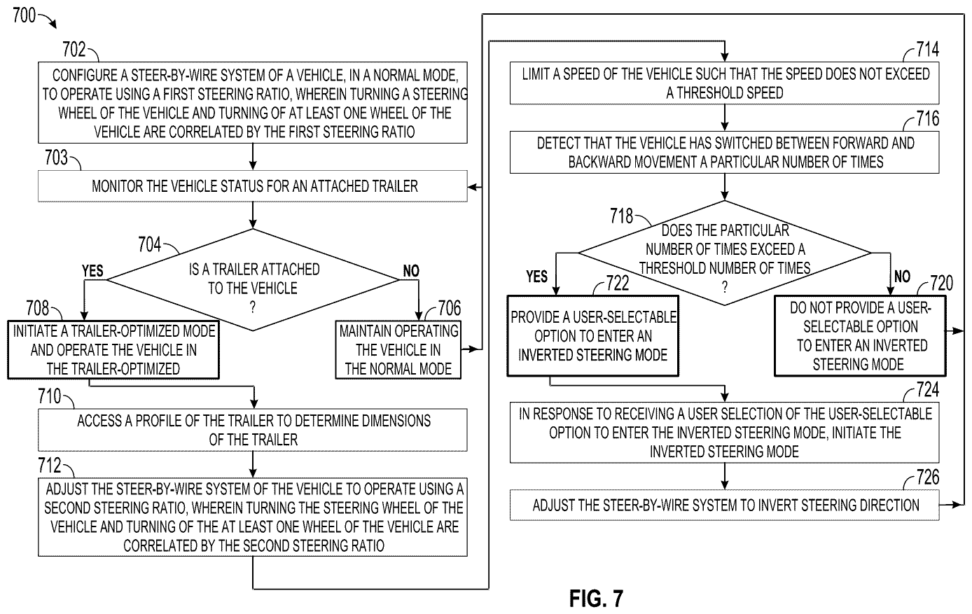

FIG. 6 depicts an SBW system (e.g., SBW system 600) configured to interface with vehicle system 670, in accordance with some embodiments of the disclosure. Although SBW system 600 depicts certain components and devices, SBW system 600 may comprise any or all of the suitable components or devices depicted in FIGS. 1-5. Additionally, SBW system 600 may be configured to execute any or all of the steps depicted in the processes disclosed in FIGS. 7-9.

Communication networks 606 and 656 may include one or more network systems, such as, without limitation, Internet, LAN, Wi-Fi or other network systems suitable for audio processing applications. In some embodiments, the system of FIG. 6 excludes server 604, and functionality that would otherwise be implemented by server 604 is instead implemented by other components of the system depicted by FIG. 6, such as one or more components of communication networks 606 and 656. In still other embodiments, server 604 works in conjunction with one or more components of communication networks 606 and 656 to implement certain functionality described herein in a distributed or cooperative manner. Similarly, in some embodiments, the system depicted by FIG. 6 excludes computing device 602, and functionality that would otherwise be implemented by computing device 602 is instead implemented by other components of the system depicted by FIG. 6, such as one or more components of communication networks 606 and 656 or server 604 or a suitable combination of the same. In other embodiments, computing device 602 works in conjunction with one or more components of communication networks 606 and 656 or server 604 to implement certain functionality described herein in a distributed or cooperative manner. In some embodiments, all communications may occur over a single communication network (e.g., communication network 606 or communication network 656). Features and operations described herein in connection with communication networks 606 and 656 may be performed by either communication network 606 or communication network 656.

Computing device 602 includes control circuitry 608, display 610 and input/output circuitry 612. Control circuitry 608 may be based on any suitable processing circuitry and includes control circuits and memory circuits, which may be disposed on a single integrated circuit or may be discrete components. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). Some control circuits may be implemented in hardware, firmware, or software. Control circuitry 608 in turn includes communication circuitry 626, storage 622 and processing circuitry 618. Storage 622 may store instructions for running the SBW application as described in connection with FIG. 1. In some embodiments, computing device 602 or control circuitry 608 may be configured as varying embodiments, or suitable combinations of varying embodiments, of FIGS. 1-5, all configured to execute the various methods as well as incorporate the various features, processes, and interfaces depicted in FIGS. 7-9.

In addition to control circuitry 608 and 634, computing device 602 and server 604 may each include storage (storage 622, and storage 638, respectively). Each of storages 622 and 638 may be an electronic storage device. As referred to herein, the phrase “electronic storage device” or “storage device” should be understood to mean any device for storing electronic data, computer software, or firmware, such as random-access memory, read-only memory, hard drives, optical drives, compact disc (CD) recorders, BLU-RAY disc (BD) recorders, BLU-RAY 3D disc recorders, digital video recorders (DVRs, sometimes called personal video recorders, or PVRs), solid state devices, quantum storage devices, gaming consoles, gaming media, or any other suitable fixed or removable storage devices, and/or any suitable combination of the same. Each of storage 622 and 638 may be used to store various types of content, metadata, and/or other types of data (e.g., they can be used to record audio questions asked by one or more participants connected to a conference). Non-volatile memory may also be used (e.g., to launch a boot-up routine and other instructions). Cloud-based storage may be used to supplement storages 622 and 638 or instead of storages 622 and 638. In some embodiments, a user profile and messages corresponding to a chain of communication may be stored in one or more of storages 622 and 638.

In some embodiments, control circuitry 608 and/or 634 executes instructions for an application (e.g., the SBW application of FIG. 1) stored in memory (e.g., storage 622 and/or storage 638). Specifically, control circuitry 608 and/or 634 may be instructed by the application to perform the functions discussed herein. In some implementations, any action performed by control circuitry 608 and/or 634 may be based on instructions received from the application. For example, the application may be implemented as software or a set of executable instructions that may be stored in storage 622 and/or 638 and executed by control circuitry 608 and/or 634. In some embodiments, the application may be a client/server application where only a client application resides on computing device 602, and a server application resides on server 604.

The application may be implemented using any suitable architecture. For example, it may be a stand-alone application wholly implemented on computing device 602. In such an approach, instructions for the application are stored locally (e.g., in storage 622), and data for use by the application is downloaded on a periodic basis (e.g., from an out-of-band feed, from an Internet resource, or using another suitable approach). Control circuitry 608 may retrieve instructions for the application from storage 622 and process the instructions to perform the functionality described herein. Based on the processed instructions, control circuitry 608 may determine a type of action to perform in response to input received from input/output circuitry 612 or from communication networks 606 and 656. For example, in response to either a first or second computing device receiving a message from either the first or second computing device, control circuitry 608 may perform the embodiments related to FIGS. 1-5 and the various processes depicted in or carried out through FIGS. 7-9.

In client/server-based embodiments, control circuitry 608 may include communication circuitry suitable for communicating with an application server (e.g., server 604) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the Internet or any other suitable communication networks or paths (e.g., communication networks 606 and 656). In another example of a client/server-based application, control circuitry 608 runs a web browser that interprets web pages provided by a remote server (e.g., server 604). For example, the remote server may store the instructions for the application in a storage device. The remote server may process the stored instructions using circuitry (e.g., control circuitry 634) and/or generate displays. Computing device 602 may receive the displays generated by the remote server and may display the content of the displays locally via display 610. This way, the processing of the instructions is performed remotely (e.g., by server 604) while the resulting displays, such as the display windows described elsewhere herein, are provided locally on computing device 604. Computing device 602 may receive inputs from the user via input/output circuitry 612 and transmit those inputs to the remote server for processing and generating the corresponding displays. Alternatively, computing device 602 may receive inputs from the user via input/output circuitry 612 and process and display the received inputs locally, by control circuitry 608 and display 610, respectively.

Server 604 and computing device 602 may transmit and receive content and data such as media content via communication networks 606 and 656. For example, server 604 may be a media content provider, and computing device 604 may be a smart television configured to download or stream media content, such as a live news broadcast, from server 604. Control circuitry 634, 608 may send and receive commands, requests, and other suitable data through communication networks 606 and 656 using communication circuitry 632, 626, respectively. Alternatively, control circuitry 634, 608 may communicate directly with each other using communication circuitry 632, 626, respectively, avoiding communication networks 606 and 656.

It is understood that computing device 602 is not limited to the embodiments and methods shown and described herein. In nonlimiting examples, computing device 602 may be an ECU of a vehicle (e.g., vehicle 670), a television, a Smart TV, a set-top box, an integrated receiver decoder (IRD) for handling satellite television, a digital storage device, a digital media receiver (DMR), a digital media adapter (DMA), a streaming media device, a local media server, a BLU-RAY player, a BLU-RAY recorder, a personal computer (PC), a laptop computer, a tablet computer, a WebTV box, a personal computer television (PC/TV), a PC media server, a PC media center, a handheld computer, a stationary telephone, a personal digital assistant (PDA), a mobile telephone, a portable video player, a portable music player, a portable gaming machine, a smartphone, or any other device, computing equipment, or wireless device, and/or suitable combination of the same capable of suitably displaying and manipulating media content.

Computing device 602 receives user input 614 at input/output circuitry 612. For example, computing device 602 may receive a user input such as a user swipe or user touch. It is understood that computing device 602 is not limited to the embodiments and methods shown and described herein. User input 614 may be received from a user selection-capturing interface that is separate from device 602, such as a remote-control device, trackpad or any other suitable user movement-sensitive, audio-sensitive or capture devices, or as part of device 602, such as a touchscreen of display 610. Transmission of user input 614 to computing device 602 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, or any other suitable wireless transmission protocol. Input/output circuitry 312 may include a physical input port such as a 3.5 mm audio jack, RCA audio jack, USB port, ethernet port, or any other suitable connection for receiving audio over a wired connection, or may include a wireless receiver configured to receive data via Bluetooth, Wi-Fi, WiMAX, GSM, UTMS, CDMA, TDMA, 3G, 4G, 4G LTE, 5G, or other wireless transmission protocols.

Processing circuitry 618 may receive user input 614 from input/output circuitry 612 using communication path 616. Processing circuitry 618 may convert or translate the received user input 614 that may be in the form of audio data, visual data, gestures or movement to digital signals. In some embodiments, input/output circuitry 612 performs the translation to digital signals. In some embodiments, processing circuitry 618 (or processing circuitry 636, as the case may be) carries out disclosed processes and methods. For example, processing circuitry 618 or processing circuitry 636 may perform the steps of the various processes depicted in or carried out through FIGS. 7-9.

Processing circuitry 618 may provide requests to storage 622 by communication path 620. Storage 622 may provide requested information to processing circuitry 618 by communication path 646. Storage 622 may transfer a request for information to communication circuitry 626 which may translate or encode the request for information to a format receivable by communication network 606 before transferring the request for information by communication path 628. Communication network 606 may forward the translated or encoded request for information to communication circuitry 632, by communication paths 630.

At communication circuitry 632, the translated or encoded request for information, received through communication path 630, is translated or decoded for processing circuitry 636, which will provide a response to the request for information based on information available through control circuitry 634 or storage 638, or a suitable combination thereof. The response to the request for information is then provided back to communication network 606 by communication path 640 in an encoded or translated format such that communication network 606 can forward the encoded or translated response back to communication circuitry 626 by communication path 642.

At communication circuitry 626, the encoded or translated response to the request for information may be provided directly back to processing circuitry 618 by communication path 654 or may be provided to storage 622 through communication path 644, which then provides the information to processing circuitry 618 by communication path 646. Processing circuitry 618 may also provide a request for information directly to communication circuitry 626 though communication path 652, where storage 626 responds to an information request, provided through communication path 620 or 644, by communication path 624 or 646 that storage 622 does not contain information pertaining to the request from processing circuitry 618.

Processing circuitry 618 may process the response to the request received through communication paths 646 or 654 and may provide instructions to display 610 for a notification to be provided to the users through communication path 648. Display 610 may incorporate a timer for providing the notification or may rely on inputs through input/output circuitry 612 from the user, which are forwarded through processing circuitry 618 through communication path 648, to determine how long or in what format to provide the notification. When display 610 determines the display has been completed, a notification may be provided to processing circuitry 618 through communication path 650.

Vehicle system 670 of FIG. 6 is communicatively coupled to communication networks 606 and 656 in order to transmit and receive instructions, statuses, and data to each of server 604 and computing device 602. Vehicle system 670 may be the same as vehicle 100 of FIG. 1, vehicle 204 of FIG. 2, or vehicle 300 of FIG. 3. For example, vehicle system 670 may receive an instruction to activate a watchdog mode from computing device 602 based on user input 614. The instruction may be transmitted via communication stream 628 to communication network 606, which then transmits the instruction with a status update to both communication circuitry 632, corresponding to server 604 (e.g., a relocation service server), via communication stream 630 and to vehicle system 670 via communication stream 658. Additionally, server 604 may also transmit a redundant security encoded iteration of the instruction to confirm the instruction with vehicle system 670 by transmitting a message via communication stream 660 through communication network 656 which is received at vehicle system 670 via communication stream 662. Control circuitry 608 and/or 634 may execute instructions from an ECU of an SBW vehicle (detected from steering actuators of the SBW vehicle) to turn at least one wheel of the SBW vehicle.

Vehicle system 670 executes a change to activate watchdog mode and executes autonomous instructions (e.g., as depicted in FIGS. 1 and 2). Once the instructions are completed, vehicle system 670 may provide new data and a new status update to computing device 602 via communication stream 664 through communication network 606 and/or may transmit the same data and/or status update to server 604 via communication network 656 using communication streams 666 and 668. Additionally, updates may be provided during execution of autonomous instructions in order to request updates (e.g., via a vehicle relocation service which generates escape trajectories to safe locations) to the autonomous instructions (e.g., there is a change in the environment around vehicle system 670 during execution of autonomous instructions and a new evasive route is needed based on real-time data collected and transmitted from vehicle system 670).

The communication paths provided in FIG. 6 between computing device 602, server 604, communication network 606, and all subcomponents depicted are exemplary and may be modified to reduce processing time or enhance processing capabilities for each step in the processes disclosed herein by one skilled in the art.

FIG. 7 is a flowchart of a detailed illustrative process 700 for enabling a trailer-optimized mode for an SBW-enabled vehicle backing a trailer, in accordance with some embodiments of this disclosure. In various embodiments, the individual steps of process 700 may be implemented by one or more components of the devices and systems of FIGS. 1-6 and may be performed in suitable combination with any of the other processes and aspects described herein. Although the present disclosure may describe certain steps of process 700 (and of other processes described herein) as being implemented by certain components of the devices and systems of FIGS. 1-6, this is for purposes of illustration only. It should be understood that other suitable components of the devices and systems may implement those steps instead.

In some embodiments, at 702, control circuitry (e.g., control circuitry 608 and/or control circuitry 634 of FIG. 6) configures an SBW system (e.g., the SBW system as described in connection with FIGS. 1-5 and/or SBW system 600 of FIG. 6) of a vehicle (e.g., vehicle 100 of FIG. 1, vehicle 204 of FIG. 2, or vehicle 300 of FIG. 3), in a normal mode, to operate using a first steering ratio (e.g., first steering ratio 118 of FIG. 1), wherein turning a steering wheel of the vehicle (e.g., steering wheel 120) and turning of at least one wheel of the vehicle (e.g., wheel 122) are correlated by the first steering ratio. For example, control circuitry operates the vehicle with first steering ratio 118 (15:1). In some embodiments, at 703, control circuitry may monitor the vehicle status for an attached trailer. Control circuitry may use the techniques described in connection with FIG. 1. In some implementations, at 704, control circuitry determines whether a trailer (e.g., trailer 102) is attached to the vehicle. In some embodiments, if control circuitry determines that a trailer is not attached to the vehicle, at 706, control circuitry maintains operating the vehicle in the normal mode. Control circuitry may optionally return back to 703 after determining that the trailer is not attached to the vehicle while operating the vehicle in the normal mode. If control circuitry determines that a trailer is attached to the vehicle, at 708, control circuitry initiates a trailer-optimized mode and operates the vehicle in the trailer-optimized mode.

In some embodiments, at 710, control circuitry accesses a profile of the trailer to determine dimensions of the trailer. Control circuitry may use the techniques described in connection with FIG. 1 to determine the dimensions of the trailer. In some implementations, at 712, control circuitry adjusts the SBW system of the vehicle to operate using a second steering ratio (e.g., second steering ratio 126 of FIG. 1) while operating in the trailer-optimized mode, wherein turning the steering wheel (e.g., steering wheel 120 of FIG. 1, steering wheel 202 of FIG. 2, or steering wheel 318 of FIG. 3) of the vehicle and turning of at least one wheel of the vehicle are correlated by the second steering ratio 126 (30:1). In some embodiments, at 714, control circuitry limits a speed of the vehicle such that the speed does not exceed a threshold speed. For example, control circuitry may limit the speed of the vehicle to three miles per hour while operating the vehicle in the trailer-optimized mode.

In some implementations, at 716, control circuitry detects that the vehicle has switched between forward and backward movement a particular number of times. For example, while operating in the normal mode, input/output circuitry (e.g., input/output circuitry 612 of FIG. 6) and/or control circuitry may detect that the vehicle has gone from reverse to drive five times within two minutes. In some embodiments, at 718, control circuitry determines whether the particular number of times exceeds a threshold number of times. In some implementations, if control circuitry determines that the particular number of times does not exceed a threshold number of times, at 720, control circuitry does not provide a user-selectable option to enter an inverted steering mode (as described in connection with FIG. 2). Control circuitry may optionally revert back to 703 after not providing a user-selectable option to enter the inverted mode. If control circuitry determines that the particular number of times exceeds a threshold number of times, at 722, control circuitry provides a user-selectable option to enter the inverted steering mode. The user-selectable option may be displayed by control circuitry on a user interface of the vehicle or may be provided to a driver of the vehicle audibly. In some implementations, at 724, in response to receiving a user selection of the user-selectable option to enter the inverted steering mode, control circuitry initiates the inverted steering mode. In some embodiments, at 726, control circuitry adjusts the SBW system to invert steering direction. Control circuitry may use techniques described in connection with FIG. 2. Control circuitry may optionally revert back to 703 after adjusting the SBW system to invert steering direction.

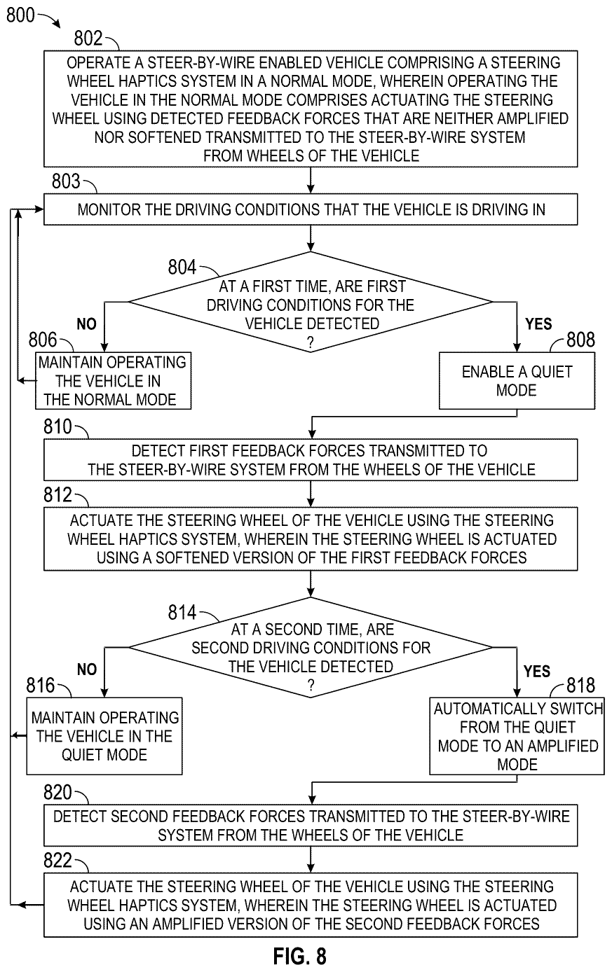

FIG. 8 is a flowchart of a detailed illustrative process 800 for enabling a quiet mode or an amplified mode of force feedback in SBW-enabled vehicles, in accordance with some embodiments of this disclosure. In various embodiments, the individual steps of process 800 may be implemented by one or more components of the devices and systems of FIGS. 1-6 and may be performed in suitable combination with any of the other processes and aspects described herein. Although the present disclosure may describe certain steps of process 800 (and of other processes described herein) as being implemented by certain components of the devices and systems of FIGS. 1-6, this is for purposes of illustration only. It should be understood that other suitable components of the devices and systems may implement those steps instead.

In some embodiments, at 802, control circuitry (e.g., control circuitry 608 and/or control circuitry 634 of FIG. 6) operates an SBW-enabled vehicle (e.g., vehicle 100 of FIG. 1, vehicle 204 of FIG. 2, or vehicle 300 of FIG. 3) comprising a steering wheel haptics system in a normal feedback mode, wherein operating the vehicle in the normal feedback mode comprises actuating the steering wheel (e.g., steering wheel 120 of FIG. 1, steering wheel 202 of FIG. 2, or steering wheel 318 of FIG. 3) using detected feedback forces that are neither amplified nor softened transmitted to the SBW system (e.g., the SBW system as described in connection with FIGS. 1-5 and/or SBW system 600 of FIG. 6) from wheels of the vehicle. In some embodiments, at 803, control circuitry monitors the driving conditions that the vehicle is driving in. Control circuitry may use techniques described in connection with FIG. 3. In some implementations, at 804, input/output circuitry (input/output circuitry 612 of FIG. 6) and/or control circuitry determines whether first driving conditions for the vehicle are detected at a first time. For example, control circuitry determines whether the vehicle is driving on a bumpy gravel road. Control circuitry may use techniques described in connection with FIG. 3.

In some embodiments, if control circuitry determines that first driving conditions for the vehicle are not detected at a first time, at 806, control circuitry maintains operating the vehicle in the normal feedback mode. Control circuitry may optionally revert to 803 after maintaining operating the vehicle in the normal feedback mode. If control circuitry determines that first driving conditions for the vehicle are detected at a first time, at 808, control circuitry enables a quiet mode for the SBW system of the vehicle. While operating in the quiet mode, in some embodiments, at 810, control circuitry detects first feedback forces transmitted to the SBW system from the wheels of the vehicle. For example, control circuitry may detect bumps on the road that the vehicle is driving on while operating in the quiet mode using techniques described in connection with FIG. 3. In some implementations, at 812, control circuitry actuates the steering wheel of the vehicle using the steering wheel haptics system, wherein the steering wheel is actuated using a softened version of the first feedback forces. For example, control circuitry reduces the first feedback forces by 30% while operating the vehicle in the quiet mode.

In some embodiments, at 814, control circuitry determines whether second driving conditions for the vehicle are detected at a second time. For example, control circuitry determines whether the vehicle is driving on a wet road. In some implementations, if control circuitry determines that second driving conditions for the vehicle are not detected at a second time, at 816, control circuitry maintains operating the vehicle in the quiet mode. Control circuitry may optionally proceed to 803 after maintaining operating the vehicle in the quiet mode. If control circuitry determines that second driving conditions for the vehicle are detected at a second time, at 818, control circuitry automatically switches from operating the vehicle in the quiet mode to an amplified mode. For example, based on determining that the vehicle is driving on a wet road, control circuitry switches from operating the vehicle in the quiet mode to the amplified mode.

In some implementations, at 820, control circuitry detects second feedback forces transmitted to the SBW system from the wheels of the vehicle. For example, control circuitry detects the road feel from the wheels of the vehicle driving on the wet road. In some embodiments, at 822, control circuitry actuates the steering wheel of the vehicle using the steering wheel haptics system, wherein the steering wheel is actuated using an amplified version of the second feedback forces. For example, control circuitry increases the second feedback forces by 40% while operating the vehicle in the amplified mode. Control circuitry may optionally proceed to 803 after actuating the steering wheel in the amplified mode.

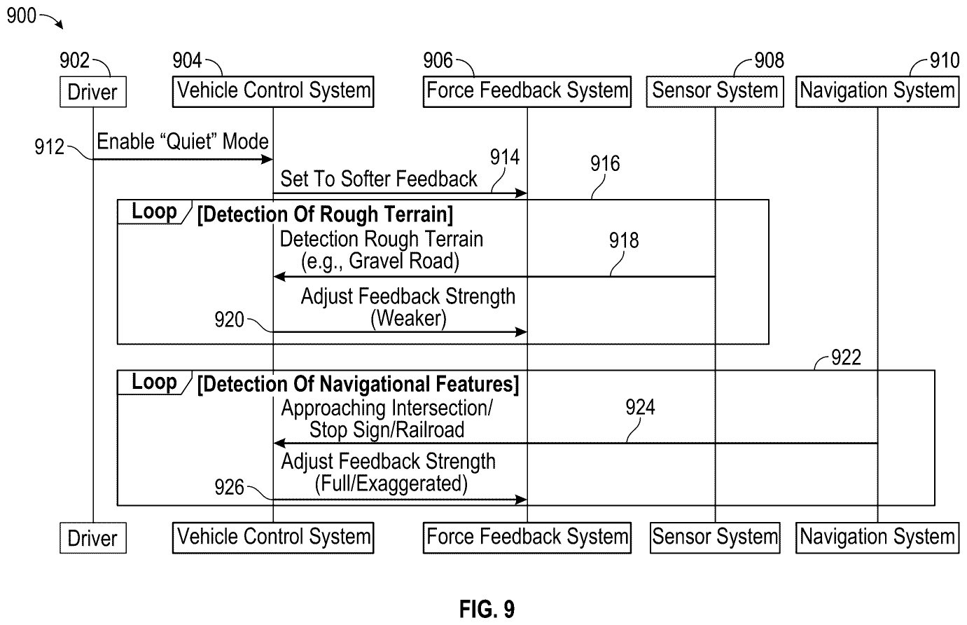

FIG. 9 is a sequence diagram of a detailed illustrative process 900 for enabling a quiet mode or an amplified mode of force feedback in SBW-enabled vehicles based on terrain type and navigational features, in accordance with some embodiments of this disclosure. In various embodiments, the individual steps of process 900 may be implemented by one or more components of the devices and systems of FIGS. 1-6 and may be performed in suitable combination with any of the other processes and aspects described herein. Although the present disclosure may describe certain steps of process 900 (and of other processes described herein) as being implemented by certain components of the devices and systems of FIGS. 1-6, this is for purposes of illustration only. It should be understood that other suitable components of the devices and systems may implement those steps instead.

In some embodiments, an SBW-enabled vehicle (e.g., vehicle 100 of FIG. 1, vehicle 204 of FIG. 2, or vehicle 300 of FIG. 3) comprising a steering wheel haptics system operates in a normal feedback mode, wherein operating the vehicle in the normal feedback mode comprises actuating the steering wheel (e.g., steering wheel 120 of FIG. 1, steering wheel 204 of FIG. 2, or steering wheel 318 of FIG. 3) using detected feedback forces that are neither amplified nor softened transmitted to the SBW system (e.g., the SBW system as described in connection with FIGS. 1-5 and/or SBW system 600 of FIG. 6) from wheels of the vehicle. In some implementations, the SBW system comprises vehicle control system 904, force feedback system 906, sensor system 908, and/or navigation system 910.

In some embodiments, at 912, driver 902 enables a quiet mode (e.g., the quiet mode as described in connection with FIGS. 3-5) for vehicle control system 904. At 914, while operating the vehicle in the quiet mode, vehicle control system 904 sends instructions to force feedback system 906 to set softer feedback. For example, if driver 902 is driving on a gravel road, or on a road with sections that cause a repetitive bump, driver 902 may enable the quiet mode that softens the feedback presented to driver 902 by force feedback system 906. In another example, vehicle control system 904 automatically enables the vehicle to operating in the quiet mode. In some embodiments, vehicle control system 904 enters detection of rough terrain loop 916. In some implementations, at 918, sensor system 908 detects rough terrain (e.g., gravel road) and transmits this data to vehicle control system 904. Navigation system 910 may also detect tough terrain. In some embodiments, at 920, vehicle control system 904 sends instructions to force feedback system 906 to adjust the feedback strength to be weaker. Force feedback system 906 may use techniques described in connection with FIG. 3 to adjust the feedback strength of the feedback forces.

In some implementations, vehicle control system 904 exits detection of rough terrain loop 916 and enters detection of navigational features loop 922. In some embodiments, at 924, navigation system 910 transmits data to vehicle control system 904 that the vehicle is approaching an intersection, stop sign, or railroad. In some implementations, vehicle control system 904 sends instructions to force feedback system 906 to adjust the feedback strength either back to its full strength (e.g., a normal feedback mode as described in connection with FIGS. 3-5) or to be exaggerated (e.g., the amplified mode as described in connection with FIGS. 3-5). In some embodiments, driver 902 may enable the adjustment of the feedback strength back to its full strength or to be exaggerated, while in other embodiments, vehicle control system 904 automatically enables the adjustment. Force feedback system 906 may use techniques described in connection with FIG. 3 to adjust the feedback strength of the feedback forces.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for operating a steer-by-wire-enabled vehicle comprising a steering wheel haptics system, the method comprising:
at a first time, detecting first driving conditions for the vehicle;
based on the detecting the first driving conditions, enabling a quiet mode;
while operating in the quiet mode:
detecting, by a steer-by-wire system, first feedback forces transmitted to the steer-by-wire system from wheels of the vehicle;
actuating a steering wheel of the vehicle using the steering wheel haptics system, wherein the steering wheel is actuated using a softened version of the first feedback forces;
at a second time, detecting second driving conditions for the vehicle;
based on the detecting the second driving conditions, automatically switching from the quiet mode to an amplified mode;
while operating in the amplified mode:
detecting, by the steer-by-wire system, second feedback forces transmitted to the steer-by-wire system from the wheels of the vehicle; and
actuating the steering wheel of the vehicle using the steering wheel haptics system, wherein the steering wheel is actuated using an amplified version of the second feedback forces.

2. The method of claim 1, further comprising:
operating the steer-by-wire-enabled vehicle in a normal feedback mode, wherein operating the steer-by-wire-enabled vehicle in the normal feedback mode comprises:
detecting, by the steer-by-wire system, third feedback forces transmitted to the steer-by-wire system from the wheels of the vehicle; and
actuating the steering wheel of the vehicle using the steering wheel haptics system, wherein the steering wheel is actuated using the third feedback forces, wherein the third feedback forces are neither amplified nor softened.

3. The method of claim 2, further comprising:
while the vehicle is operating in the normal feedback mode:
automatically switching to operating the vehicle in the quiet mode based on predicting a first frequency of steering wheel turns lower than a first threshold frequency of steering wheel turns.

4. The method of claim 2, further comprising:
while the vehicle is operating in the normal feedback mode:
automatically switching to operating the vehicle in the amplified mode based on predicting a second frequency of steering wheel turns higher than a second threshold frequency of steering wheel turns.

5. The method of claim 2, further comprising:
while the vehicle is operating in either the normal feedback mode or the quiet mode:
detecting inattentive driving based on at least one sensor of the vehicle; and
based on the detecting the inattentive driving, automatically switching to operating the vehicle in the amplified mode.

6. The method of claim 2, further comprising:
accessing a driver profile comprising tracked driving behavioral data;
based on the tracked driving behavioral data, determining overcorrecting driving is likely when the vehicle is driving in the first driving conditions;
detecting that the vehicle is driving in the first driving conditions while the vehicle is operating in the normal feedback mode; and
based on the detecting, automatically switching from the normal feedback mode to the quiet mode.

7. The method of claim 2, further comprising:
accessing a driver profile comprising tracked driving behavioral data;
based on the tracked driving behavioral data, determining undercorrecting driving is likely when the vehicle is driving in the second driving conditions;
detecting that the vehicle is driving in the second driving conditions while the vehicle is operating in the normal feedback mode; and
based on the detecting, automatically switching from the normal feedback mode to the amplified mode.

8. The method of claim 2, further comprising, while operating in the normal feedback mode:
detecting a type of terrain that the vehicle is driving on;
based on the type of terrain, automatically switching from the normal feedback mode to either the quiet mode or the amplified mode,
wherein the first driving conditions and the second driving conditions comprise a type of terrain that the vehicle is driving on.

9. The method of claim 2, further comprising:
while the vehicle is operating in either the normal feedback mode or the quiet mode:
accessing a driver profile of the vehicle;
determining that a driver of the driver profile is hearing-impaired based on at least one of data of the driver profile or a current intensity level of auditory signals within the vehicle surpassing a threshold intensity level; and
based on the determining, automatically switching from either the normal feedback mode or the quiet mode to the amplified mode.

10. The method of claim 9, further comprising:
translating external auditory signals into physical feedback forces; and
actuating the steering wheel of the vehicle using the steering wheel haptics system, wherein the steering wheel is actuated using the physical feedback forces.

11. The method of claim 1, wherein the automatically switching from the quiet mode to the amplified mode is based on at least one of a change in driving conditions, the vehicle entering a geofenced location, or a predicted change in driving conditions.

12. The method of claim 11, wherein predicting the predicted change in driving conditions comprises at least one of:
(a) determining that the vehicle will enter the geofenced location within a threshold amount of time;
(b) determining that the vehicle is approaching an obstacle; or
(c) detecting a change in weather conditions.

13. A system for operating a steer-by-wire-enabled vehicle comprising a steering wheel haptics system, the system comprising:
input/output circuitry configured to:
at a first time, detect first driving conditions for the vehicle;
control circuitry configured to:
based on the detecting the first driving conditions, enable a quiet mode;
while operating in the quiet mode:
detect, by a steer-by-wire system, first feedback forces transmitted to the steer-by-wire system from wheels of the vehicle;
actuate a steering wheel of the vehicle using the steering wheel haptics system, wherein the steering wheel is actuated using a softened version of the first feedback forces;
wherein the input/output circuitry is further configured to:
at a second time, detect second driving conditions for the vehicle;
wherein the control circuitry is further configured to:
based on the detecting the second driving conditions, automatically switch from the quiet mode to an amplified mode;
while operating in the amplified mode:
detect, by the steer-by-wire system, second feedback forces transmitted to the steer-by-wire system from the wheels of the vehicle; and
actuate the steering wheel of the vehicle using the steering wheel haptics system, wherein the steering wheel is actuated using an amplified version of the second feedback forces.

14. The system of claim 13, wherein the control circuitry is further configured to:
operate the steer-by-wire-enabled vehicle in a normal feedback mode, wherein operating the steer-by-wire-enabled vehicle in the normal feedback mode comprises:
detecting, by the steer-by-wire system, third feedback forces transmitted to the steer-by-wire system from the wheels of the vehicle; and
actuating the steering wheel of the vehicle using the steering wheel haptics system, wherein the steering wheel is actuated using the third feedback forces, wherein the third feedback forces are neither amplified nor softened.

15. The system of claim 14, wherein the control circuitry is further configured to:
while the vehicle is operating in the normal feedback mode:
automatically switch to operating the vehicle in the quiet mode based on predicting a first frequency of steering wheel turns lower than a first threshold frequency of steering wheel turns.

16. The system of claim 14, wherein the control circuitry is further configured to:
while the vehicle is operating in the normal feedback mode:
automatically switch to operating the vehicle in the amplified mode based on predicting a second frequency of steering wheel turns higher than a second threshold frequency of steering wheel turns.

17. The system of claim 14, wherein the control circuitry is further configured to:
while the vehicle is operating in either the normal feedback mode or the quiet mode:
detect inattentive driving based on at least one sensor of the vehicle; and
based on the detecting the inattentive driving, automatically switch to operating the vehicle in the amplified mode.

18. The system of claim 14, wherein the control circuitry is further configured to:
access a driver profile comprising tracked driving behavioral data;
based on the tracked driving behavioral data, determine overcorrecting driving is likely when the vehicle is driving in the first driving conditions;
detect that the vehicle is driving first driving conditions while the vehicle is operating in the normal feedback mode; and
based on the detecting, automatically switch from the normal feedback mode to the quiet mode.

19. The system of claim 14, wherein the control circuitry is further configured to:
access a driver profile comprising tracked driving behavioral data;
based on the tracked driving behavioral data, determine undercorrecting driving is likely when the vehicle is driving in the second driving conditions;
detect that the vehicle is driving in second driving conditions while the vehicle is operating in the normal feedback mode; and
based on the detecting, automatically switch from the normal feedback mode to the amplified mode.

20. The system of claim 14, wherein the control circuitry is further configured to, while operating in the normal feedback mode:
detect a type of terrain that the vehicle is driving on;
based on the type of terrain, automatically switch from the normal feedback mode to either the quiet mode or the amplified mode,
wherein the first driving conditions and the second driving conditions comprise a type of terrain that the vehicle is driving on.

21-60. (canceled)
